(19) United States
(12) Patent Application Publication
(10) Pub. No.: US 2010/0153375 A1
(43) Pub. Date: Jun. 17, 2010

(54) System and method for classifying and storing related forms of data

(75) Inventors: Angelos Bilas, Heraklion (GR); Michail Flouris, Heraklion (GR)

Correspondence Address: STEPTOE & JOHNSON LLP, 1330 CONNECTICUT AVENUE, N.W., WASHINGTON, DC, 20036, US

(73) Assignee: Foundation for Research and Technology - Hellas (Institute of Computer Science --FORTH-ICS), Heraklion (GR)

(21) Appl. No.: 12/314,758

(22) Filed: Dec. 16, 2008

(51) Int. Cl. G06F 17/00

(52) U.S. Cl. 707/723; 707/E17.005

(57) ABSTRACT

A method for managing data and corresponding computer program are provided. The method includes providing a plurality of buckets, each associated with a corresponding scope of similarity metric, processing a first data container of a plurality of data containers to determine a corresponding similarity metric, comparing the similarity metric of the first data container with the scope of similarity metric of the plurality of buckets, assigning, if the similarity metric of the first data container matches the scope of similarity metric of any of the plurality of buckets and the corresponding bucket has sufficient available space, the first data container with the corresponding one of the plurality of buckets, creating, if either the similarity metric of the first data container does not match the scope of similarity metric of any of the plurality of buckets or a match is present but any of the corresponding buckets do not have sufficient available space, a new bucket for the plurality of buckets, and subsequently associating the first data container with the bucket; and compressing as a unit, when at least one condition is met, any of the plurality of data containers assigned by the assigning to a particular one of the plurality of buckets.

### BACKGROUND OF THE INVENTION

1. Field of the Invention

The present invention relates to methods for reducing the size required to store data files. More specifically, the present invention relates to a methodology for organizing and storing data files based on similarity between the files.

2. Discussion of Background Information

Today's applications and computer users create significant redundancy in their stored data. For example, a user may create a document in MICROSOFT WORD, which is written into memory as first originating copy of the document. This WORD file can then be emailed to various different people within the organization, each email generating an additional copy that is stored somewhere within the system. Some individuals may then store the copy in a new file within the system for later use. These multiple copies of the file can occupy a considerable degree of storage space in memory.

A solution that identifies and removes this unnecessary redundancy is expected to increase the efficiency of storage usage, lowering the associated costs of acquiring and maintaining storage. However, attempts to reduce this redundancy have had limited applicability.

One common method is to address the problem manually, in that duplicate copies of the file are located and deleted and/or replaced with a pointer to a master copy. However, such manual methods are time consuming, and it is often difficult to effectively locate all of the copies. The possibility of error, in that the wrong file can be deleted, is also quite high. The manual method is also useless when files are similar, rather than identical.

Automatic methods work on the principles of de-duplication in that the computer system (loosely a collection of computer and/or network of related hardware and/or software components, whether in a single location or dispersed over multiple locations) can seek out (at the file, file-segment, block, or other level) identical replicas of files, parts of files (segments), or data blocks are identified and mapped to a single physical copy of the file, segment, or block, respectively. File-level de-duplication requires knowledge of the internal operation of the file system and often requires modifications to it. Segmented file-based de-duplication has similar disadvantages with the additional challenge of identifying appropriate segments within a file that are suitable for de-duplication. Block-level de-duplication has the advantage that is transparent to the file system and does not require modifications to it. However, small blocks that are similar but not identical are currently not handled by any existing techniques. These methods also do not provide any savings for the other portions of the file segment or block that are not identical.

There are also automated solutions based on data compression (the process of encoding information using fewer bits (or other information-bearing units) than an unencoded representation would use through use of specific encoding schemes. Examples include the ZIP file format (which also acts as an archiver—storing many source files in a single destination output file) and the gzip utility). Compression techniques at the file or segment level are typically implemented on top of a layer that provides variable size read and write operations to storage. However, compression is still generally limited in application to individual files and may be performed after a deduplication method has been applied.

The above methods do not handle well data that is similar but not identical. Also, compressing large files as a single entity is impractical for files that require updating. For example, the drain on storage increases geometrically when various individuals with access to the electronic copies of documents begin to modify the document. Despite the edits, the various edited copies will likely have considerable overlap with the prior versions and other edited versions. Yet each version is stored as a separate file and utilizes as much space as independently required.

The noted prior art solutions do not efficiently remove data redundancy across different small blocks, files, or file segments stored in a storage system and remain transparent to the file system and other higher system layers. In de-duplication techniques, this is because of a typical minimum size limit (e.g., 8 KB average segment size) in its detection of duplicates. Reducing segment size to very small sizes makes this approach impractical. Although compression techniques do not typically have a minimum size limit, they typically compress individual and larger blocks, files, or file-segments and cannot remove redundancy across different (and especially smaller) blocks, files or file-segments. Finally, combining a large number of blocks or files blindly in a single unit for compression is impractical for performance reasons: updating any single file will require first decompressing everything, then performing the update, and then re-compressing everything.

### SUMMARY

It is accordingly an object of the invention to provide a file storage methodology that overcomes various drawbacks of the prior art.

According to an embodiment of the invention, a method for managing data is provided. The method includes providing a plurality of buckets, each associated with a corresponding scope of similarity metric, processing a first data container of a plurality of data containers to determine a corresponding similarity metric, comparing the similarity metric of the first data container with the scope of similarity metric of the plurality of buckets, assigning, if the similarity metric of the first data container matches the scope of similarity metric of any of the plurality of buckets and the corresponding bucket has sufficient available space, the first data container with the corresponding one of the plurality of buckets, creating, if either the similarity metric of the first data container does not match the scope of similarity metric of any of the plurality of buckets or a match is present but any of the corresponding buckets do not have sufficient available space, a new bucket for the plurality of buckets, and subsequently associating the first data container with the bucket; and compressing as a unit, when at least one condition is met, any of the plurality of data containers assigned by the assigning to a particular one of the plurality of buckets.

The above embodiment may have various optional features. After the compressing, the compressed bucket can be stored into one or more fixed size extents. When at least one condition is met, the assignment of data containers to compressed buckets can be rearranged, such that the compressed buckets are smaller in size than prior to the reorganizing. The at least one reorganizing condition includes any of executing the assigning step, executing the compression step, a pre-set time, a pre-set interval relative to a prior reorganization, after a predetermined number of buckets are stored in a memory, a detected period of low system activity, or available storage space for the buckets is below a threshold. The processing can be responsive to at least one of a request to write an individual data container, a predetermined number of write requests for individual data containers, a pre-set time, or a pre-set interval relative to a prior processing. If during the assigning, competing availability exists between multiple buckets within the plurality of buckets to receive the data container, and then the competing availability can be resolved by at least one of the first identified available bucket, the oldest bucket, or the most efficient overall placement. The scope of similarity metric can be at least one of a single similarity metric, a plurality of similarity metrics, or one or more ranges of similarity metrics, or a similarity metric with an associated degree of flexibility. Additional steps may include receiving a second data container, determining whether the second data container is identical to any of the plurality of data containers that has been previously assigned to one of the plurality of buckets, and the assigning being contingent upon a negative result of the determining. At least two data containers could be assigned by the assigning to a common bucket, and wherein the compressing can substantially eliminate redundancy between the at least two data containers while preserving differences between the at least two non-identical data containers. Other additional steps may include storing in at least one directory the relationship between the first data container, the corresponding similarity metric, the assigned bucket, and the location of the assigned bucket as compressed in memory. A predetermined policy may be provided for determining a size and storage location of buckets within storage based on at least one characteristic of any data containers associated with particular buckets, the at least one characteristic including an access characteristic and the reorganizing may be at least partially based on the predetermined policy.

According to another embodiment of the invention, a computer program in computer readable format stored on a computer readable medium is provided. The computer program is configured to operate in conjunction with a computer system to manage data according to various steps. These steps include providing a plurality of buckets, each associated with a corresponding scope of similarity metric, processing a first data container of a plurality of data containers to determine its similarity metric, comparing the similarity metric of the first data container with the scope of similarity metric of the plurality of buckets, assigning, if the similarity metric of the first data container matches the scope of similarity metric of any of the plurality of buckets and the corresponding bucket has sufficient available space, the first data container with the corresponding one of the plurality of buckets, creating, if either the similarity metric of the first data container does not match the scope of similarity metric of any of the plurality of buckets or a match is present but any of the corresponding buckets do not have sufficient available space, a new bucket for the plurality of buckets, and subsequently associating the first data container with the bucket, and compressing as a unit, when at least one condition is met, any of the plurality of data containers assigned by the assigning to a particular one of the plurality of buckets.

The above computer program may be configured to perform various optional steps, including: storing, after the compressing, the compressed bucket into a fixed sized extent; rearranging, when at least one condition is met, the assignment of data containers to compressed buckets, such that as a result of the reorganizing the compressed buckets are smaller in size than prior to the reorganizing; the at least one condition includes any of said assigning, said compressing, a pre-set time, a pre-set interval relative to a prior reorganization, after a predetermined number of buckets are stored in a memory, a detected periods of low system activity, or available storage space for the buckets is below a threshold; the processing is responsive to at least one of a request to write an individual data container, a predetermined number of write requests for individual data containers, a pre-set time, or a pre-set interval relative to a prior processing; if during the assigning, competing availability exists between multiple buckets within the plurality of buckets to receive the data container, then the competing availability may be resolved by at least one of the first identified available bucket, the oldest bucket, or the most efficient overall placement; the scope of similarity metric is at least one of a single similarity metric, a plurality of similarity metrics, or one or more ranges of similarity metrics, or a similarity metric with an associated degree of flexibility. Additional optional steps performed by the program may include: receiving a second data container, determining whether the second data container is identical to any of the plurality of data containers that has been previously assigned to one of the plurality of buckets, and the assigning being contingent upon a negative result of the determining. At least two non-identical data containers will be assigned by the assigning to a common bucket, and wherein the compressing will substantially eliminate redundancy between the at least two non-identical data containers while preserving differences between the at least two non-identical data containers. Another optional additional step includes storing in at least one directory the relationship between the first data container, the corresponding similarity metric, the assigned bucket, and the location of the assigned bucket as compressed in memory.

Other exemplary embodiments and advantages of the present invention may be ascertained by reviewing the present disclosure and the accompanying drawings.

### BRIEF DESCRIPTION OF THE DRAWINGS

The present invention is further described in the detailed description which follows, in reference to the noted plurality of drawings by way of non-limiting examples of certain embodiments of the present invention, in which like numerals represent like elements throughout the several views of the drawings, and wherein:

FIG. 1 illustrates a block diagram of the components of an embodiment of the invention;

FIG. 2 illustrates a high level flowchart of an embodiment of the invention;

FIG. 3 illustrates a flowchart of a bucket assignment methodology of an embodiment of the invention;

FIGS. 4-19 are more detailed flowcharts of an embodiment of the invention.

### DETAILED DESCRIPTION OF EXEMPLARY EMBODIMENTS

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

The concepts of an embodiment of the invention are best understood with respect to collections of data (referred to herein as “data containers”). A data container is a collection of data within the computer system at a particular level, e.g., file, file segment, or blocks (a block is a basic unit of access for a storage medium), but for ease of explanation, reference will be made to files without intending to limit the invention to files.

The data within the container may be compressed or uncompressed. Each data container preferably has a unique identifier, e.g., a logical block number, filename, or a combination of the filename, offset and size. The data within a WORD file is an example of a data container. The disk blocks that comprise the WORD file are other examples of data containers.

A goal of certain embodiments of the invention is to avoid the need for identical data within the prior art and instead focus on similar data, which includes both identical data and deviations from the identical within an acceptable degree. According to a preferred embodiment of the invention, four overall steps are applied:

(a) Identify similarity between data containers;

(b) Classify data containers into related groups (referred to herein as “buckets”);

(c) Compress several entities within a bucket as a unit; and

(d) Store compressed buckets as fixed size extents on a computer storage medium.

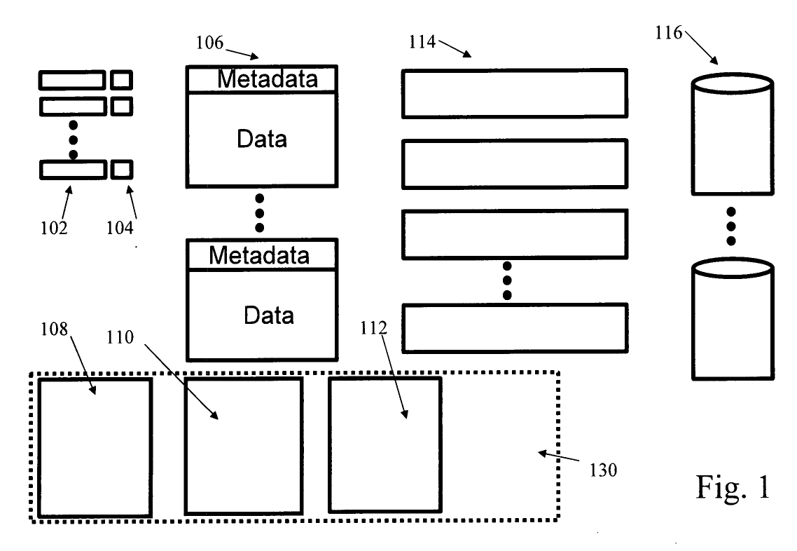

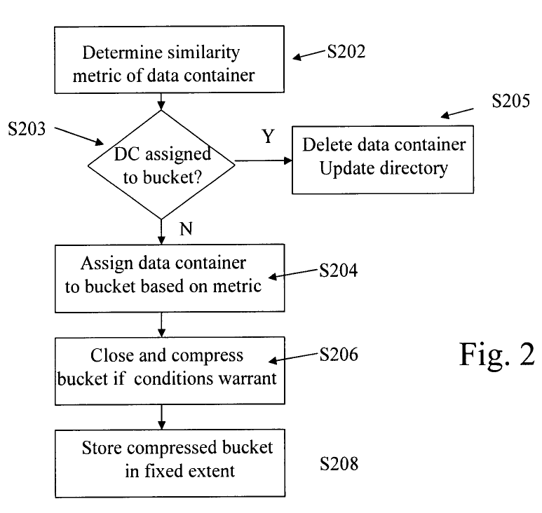

Non-limiting examples of the above steps are shown with respect to FIGS. 1 and 2. A data container 102 of data is in a computer memory (e.g., any hardware or combination of hardware and software that stores data, such as but not limited to an optical disk, magnetic disk and/or flash memory, DRAM, whether in a single location or dispersed over multiple locations). The location of the data container within the system is stored in a data container directory 108 portion of a master directory 130.

Master directory 130 is an amorphous concept that refers to the aggregate collection of the various individual directories discussed herein, as well as any other directories as may be appropriate. It may be in a central or single location, or dispersed amongst multiple locations. Similarly, the individual directories (e.g., 108 and 110) may be in a central or single location, or dispersed amongst multiple locations. These directories may be, for example, individual and distinct data containers, or common files with overlapping content. The nature of the directories is to be considered flexible, and not a limiting component of the invention.

In response to a write request for a data container 102, at step S202, an algorithm is applied to the data container 102 that determines characteristics of data container in the form of an objective similarity metric 104. A non-limiting example of such a metric would be a numerical value, although other representation formats could be used. A similarity metric 104 need not be unique to any particular data container 102. The invention is not confined to any particular algorithm or representational format.

A non-limiting example of an algorithm applied at step S202 is as follows:

1. Compute the distribution of values of all fixed-size data units (such as 8-bit bytes) within the data container 102. Assume that data container 102 contains p such distinct values. In general, a data container contains w₁ bytes with value v₁; w₂ bytes with value v₂. . . ; and wₚ bytes with value vₚ;

2. Create a sorted list of the in most frequent such values (m<p) of data container 102;

3. Take all combinations of k out the m above values (k<m).

The resulting metric 104 of this embodiment consists of the resulting combinations.

Application of the above method can be seen with respect to three (3) different data containers 102, each a WORD document containing the following:
DC 1: “An innovation is an idea of practical application which is different than standard doctrine, form, or practice.\n An innovation is an idea of practical application which is different than standard doctrine, form, or practice.\n An innovation is an idea of practical application which is different than standard doctrine, form, or practice.\n”
DC 2: “An innovation is an idea of application which is different than standard doctrine.\nAn innovation is an idea of application which is different than standard doctrine.\n An innovation is an idea of application which is different than standard doctrine.\n”
DC 3: “Innovations fall into categories such as: processes for making something. . . \n Innovations fall into categories such as: processes for making something . . . \n Innovations fall into categories such as: processes for making something . . . \n”
   None of the above data containers 102 are identical, but each has a certain degree of overlap, and thus a degree of similarity. As will be discussed below, storage savings can be obtained if those data containers that are sufficiently similar are grouped together for common compression.

Applying the above-noted example of an algorithm to each of data containers DC1-3, step S202 would produce for m=4, k=m similarity metrics as follows:
SV for DC1=[SPACE,a,i,n]
SV for DC2=[SPACE,a,i,n]
SV for DC3=[SPACE,n,o,s]
   The application of the algorithm in step S202 thus provides identical similarity metrics 104 for the data containers 102 DC1 and DC2, but a different one for DC3. This indicates that storage savings can be achieved by storing DC1 and DC2 together. As discussed more fully below, this will effect how the various data containers DC1-3 will be organized for subsequent storage.

Another non-limiting example of such an algorithm at step S202 is as follows:

1. Compute an identity hash (e.g. MD5, SHA1) for each sub-piece of fixed size s of data container 102. Sub-pieces may be variable size or average size s to capture shifted patterns. Such sub-pieces can be calculated using a fingerprinting algorithm, such as described in WO 2005114484.

2. Count the number of times each hash appears in data container 102.

3. Create a (frequency-based) sorted list of the n most frequent identity hashes.

4. Take all combinations of k out the n above values (k<n).

The resulting metric 104 of this embodiment consists of these combinations.

Yet another non-limiting example of such an algorithm is to find in data container 102 all patterns repeated more than once and their frequencies. Signature metric 104 would be the function of the patterns themselves, their length, and the frequency.

Other possible examples of similarity metrics include: a statistical metric that is computed over the compressed data containers rather than the uncompressed data containers; a hint or metric contained in the data container (other system components that create data containers may use private metrics for generating the similarity signature and storing it in the data container itself); and a metric provided along-side the data containers by other system components.

At step S203 the system determines whether the specific data container 102 is already associated with some existing bucket 106 (whether currently open or previously compressed and saved). If the answer is yes, then at step S205 the contents of the particular data container 102 are first removed from the old bucket 106. Then, control continues to step S204 as if the data 102 container was not previously assigned to an existing bucket 106. In the alternative, at step S205 the new redundant data container can be deleted and replaced with a pointer to the existing copy that is already associated with an existing bucket 106.

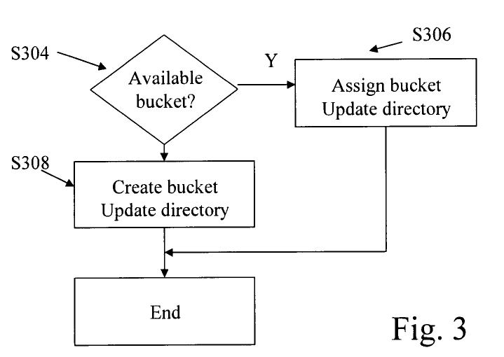

If the specific data container 102 has not been previously assigned to some existing bucket 106 (which represents a first write case for the particular data container 102), then at step S204, the data container 102 is assigned to an appropriate bucket 106 based on its metric 104. FIG. 3 shows a non-limiting example of the underlying processing. The system determines at step S304 whether a bucket 106 already exists that can accommodate the data container 102. As discussed below, each bucket 106 has an assigned similarity metric(s) and/or range of similarity metrics; step S304 thus entails comparing the similarity metric 104 of the particular data container 102 with the similarity metric(s) or ranges of the similarity metrics of the available buckets 106. If the similarity metric 104 matches (e.g., is identical to one or more metrics and or falls within the range of a bucket 106 that has sufficient space to accommodate the data container 102), then data container 102 is assigned to that bucket 106 at step S306. Data container directory 108, and a bucket directory 110 (which may contain, e.g., location of the buckets 106, their contents, size, etc.) are all updated as appropriate.

There may be on occasion multiple buckets 106 that can accommodate the particular data container 102. Competing availability can be resolved in a variety of different ways. Non-limiting examples include priority to the first identified available bucket 106, the oldest bucket 106, the most efficient placement to make full use of the data container 102, or combination thereof.

If no bucket 106 is available (either because no bucket 106 has a range of similarity metrics that encompasses similarity metric 104 of the particular data container 102, or the only bucket 106 that does lacks sufficient space) then control passes to step S308 to create a new bucket 106. Data container 102 is then assigned to the new bucket 106. Data container directory 108, and bucket directory 110 are all updated as appropriate. The newly created bucket 106 is now available to receive additional data containers 102.

Based on the parameters of the system, establishing the bucket at step S308 may also include establishing a degree of flexibility (which may be pre-established by rule, determined in real time, or a combination thereof) for the bucket based on the similarity metric 104 of the data container 102 that established that particular bucket. A non-limiting example would be to create a plus or minus range about similarity metric 104 of the data container 102.

Establishment of a degree of flexibility can be omitted and/or the range of flexibility can be set to zero if identical similarity metrics are desired for the contents of particular buckets 106. This may be the case when the algorithm applied at step S202 already has a built in degree of flexibility in the resulting similarity metric 104. By way of example, and as discussed in more detail below, this could be the case for the above example of DC1-DC3, in which the applied algorithm resulted in identical similarity metrics for different data containers DC1 and DC2.

A non-limiting example of the above steps based on a numeric representation format are as follows with reference to the contents of a bucket directory 110. Initially, bucket directory 110 will be empty, as no data container has yet been assigned to a bucket 106.

| Bucket 106 # | Assigned similarity metric(s) 104 | Data Container 102 #'s |
|---|---|---|
| Empty | Empty | Empty |

A first data container 102(1) is determined to have a similarity metric 104 with a value of 500. No bucket 106 exists that can accommodate that value, so a new bucket 106(1) is created. By rule, a new bucket will be assigned a range of plus/minus 50 relative to the similarity metric 104 that established it; this represents that while other data containers may not be identical to the first data container 102(1), if by metric they are close enough (within 50), then they should be grouped together for storage purposes. The newly created first bucket 106 (1) will thus have a similarity metric range of 450-550. The first data container 102 is assigned to this first bucket 106. Bucket directory 110 is updated as follows:

| Bucket 106 # | Assigned similarity metric(s) 104 | Data Container 102 #'s |
|---|---|---|
| (1) | 450-550 | 102(1) |

At a later point in time, a second data container 102(2) is determined to have a similarity metric 104 with a value of 525. (As suggested by the similarity metric, this second data container 102(2) has potentially a great deal in common with the first data container 102(1), but the two are not identical.) Since the 525 value falls within the range of the 450-550 for the first bucket 106(1), this second data container 102(2) will be assigned thereto. Bucket directory 110 is updated as follows:

| Bucket 106 # | Assigned similarity metric(s) 104 | Data Container 102 #'s |
|---|---|---|
| (1) | 450-550 | 102(1); 102(2) |

At a later point in time, a third data container 102(3) is determined to have a similarity metric 104 with a value of 475. (As suggested by the similarity metric, this third data container 102(3) has a great deal in common with the first and second data containers 102(1)(2), but none are identical.) Since 475 is within the range of the 450-550 for the first bucket 106(1), this third data container 102(3) will be assigned thereto if there is room. However, if there is not enough room, then the system will establish a second bucket 106(2) with a range of 425-525 (475 plus/minus 50) and assign the third data container 102 to that second bucket 106. Assuming a lack of room, Bucket directory 110 would reflect as follows:

| Bucket 106 # | Assigned similarity metric(s) 104 | Data Container 102 #'s |
|---|---|---|
| (1) | 450-550 | 102(1); 102(2) |
| (2) | 475-525 | 102(3) |

The above process continues with closing and compression of buckets 106 as necessary, with the corresponding opening of new buckets to receive new data containers 102.

Another non-limiting example of the above steps based on a codex representation format is as follows. For this example, consider the above-described three data containers DC1-DC3 discussed above written in succession for the first time.

The first data container DC1 is determined to have a similarity metric 104 of [SPACE,a,i,n]. No bucket 106 exists that can accommodate that metric, so a new bucket 106 is created and assigned the same similarity metric of [SPACE,a,i,n] that established it. No range of flexibility is established in this example, as the algorithm from step S202 itself will account for a degree of similarity. Data container DC1 is assigned to this first bucket 106, and the requisite directories within master directory 130 as updated as appropriate. Bucket directory 110 is updated as follows:

| Bucket 106 # | Assigned similarity metric(s) 104 | Data Container 102 #'s |
|---|---|---|
| (1) | [SPACE, a, i, n] | DC1 |

At a later point in time, data container DC2 is determined to have a similarity metric 104 of [SPACE,a,i,n]. As suggested by the fact that the similarity metric of DC1 and DC2 are identical, data container DC2 has a great deal in common with the data container DC2, even though they are not identical. The second data container DC2 will therefore be assigned to the same bucket 106 (presuming that room exists). Bucket directory 110 is updated as follows:

| Bucket 106 # | Assigned similarity metric(s) 104 | Data Container 102 #'s |
|---|---|---|
| (1) | [SPACE, a, i, n] | DC1; DC2 |

At a later point in time, the third data container DC3 102 is determined to have a similarity metric 104 of [SPACE,n,o,s]. Based on the applied algorithm at step S202, the resulting metric represents that DC3 did not have enough similarity with DC1 and DC2 to receive the same similarity metric, and will therefore be assigned to a different bucket 106. Bucket directory 110 is updated as follows:

| Bucket 106 # | Assigned similarity metric(s) 104 | Data Container 102 #'s |
|---|---|---|
| (1) | [SPACE, a, i, n] | DC1; DC2 |
| (2) | [SPACE, n, o, s] | DC3 |

In yet another example, a bucket could be assigned multiple similarity metrics. For example, it is possible that a bucket could be configured to accept [SPACE,a,i,n] [SPACE,n,o,s] because they have a common “n.” A bucket can thus be assigned, for example, a single metric, multiple different metrics, a range(s) of metrics, or combinations thereof. Applicants refer to this range of possible assignments as a “scope of similarity metric.”

The above write request processing may be triggered by a variety of methods. For example, the process could trigger every time a data container 102 is written. In the alternative, the system could trigger after a predetermined number of write requests are made, at periodic intervals, or other times and/or conditions as may be appropriate. Although the steps are described in the embodiment as occurring in the order presented and for a single data container 102, the invention is not so limited. The steps may be reordered and/or combined as convenient, and multiple data containers 102 may be processed in bulk for each step.

Returning now to FIGS. 1 and 2, at step S206 the system determines whether conditions are appropriate to close and store the particular bucket 106 that just received the new data container 102. If such conditions are met, then all of the data containers 102 assigned to the bucket 106 are compressed as a single unit using a desired compression technique (the invention is not limited to any particular technique). By virtue of the fact that similar data containers 102 were grouped together, all of the data containers within in the bucket 106 will typically have a considerable degree of redundancy that will be eliminated by the compression methodology. Once a bucket is compressed, at step S208 it is stored in one or more fixed size extents 114 for subsequent storage on a storage media 116.

There are a variety of conditions that may trigger the closure of a bucket 106. The most absolute example is when a bucket 106 is full and therefore cannot hold any more data containers at all. Another example is when bucket 106 is not yet full but is beyond a threshold (either for example, predetermined or derived in real time based on current conditions) such that it is unlikely that it could hold another data container 102. Yet another example is when the bucket has been open for an extended period of time (either for example, a predetermined time or derived time based on current conditions). Combinations are also possible; for example, an initial threshold value may be applied and then lowered over time as the bucket ages. The invention is not limited to any particular set of conditions.

Although steps S202-S206 are shown sequentially in the flowchart of FIG. 2, the invention is not so limited. Steps S202 and/or S204 can run iteratively (as buckets can be considered as data containers themselves) while step S206 is a separate process that runs in parallel. For example, buckets 106 could be checked at step S208 after every 10 data containers 102 are written thereto, and those buckets 106 which are ready for compression are then compressed by independent processing.

There are also a variety of conditions that may trigger the storage of an extent 114 on storage media 116. Specifically, data containers 102 are generally of variable size, such that the resulting buckets 106 are also of variable size over time and in general do not precisely fit fixed-sized extents 114. As the rate of filling a bucket 106 depends on the rate at which similar (compressed or uncompressed) data containers 102 arrive at the classifier, which may vary over time, deciding when to write an extent to disk is a policy that may take into account (at least) any of the following considerations: (a) a measure of space utilization for the extent deeming its current utilization sufficient-an example of such a measure could be a percentage of space utilized or inability to find space to fit one or more additional data containers into the extent 114; (b) a measure of memory resources available to maintain the extent in memory, justifying holding the extent in memory in anticipation of a (compressed or uncompressed) data container 102 of sufficient size.

Thus, an extent 114 may be thought of as a contiguous fixed-size disk abstraction. A bucket 106 may be thought of as a variable-size abstraction of non-contiguous disk space that simply groups similar data containers 102, based on their similarity metrics 104. Buckets are placed in memory for buffering or caching purposes. Buckets that have been written to disk can be brought back to memory for adding more data containers to them, or for reorganization purposes, updating at the same time all relevant directory information. Buckets that reside in memory may be compressed incrementally as data containers are added or once before they are written to disk. New, incoming data containers can be assigned to any bucket on disk or in memory. The number and size of buckets 104 and extents 114 as well as the number of buckets and extents that reside in memory can be tuned based on application behavior and data parameters either statically or at runtime.

The improvement provided by the instant embodiments can be seen with respect to the conservation of memory space with respect to DC1-3 above. Each has a size 339, 252, and 234 bytes, respectively. As none of the data containers DC1-DC3 are identical, under prior art methodologies they would be compressed individually; based on standard gzip utility in a UNIX system, the resulting compressed file sizes would be 115, 99, and 99 bytes respectively, for a total of 313 bytes of required memory space. In contrast, by application of the embodiments herein, DC1 and DC2 would be compressed as a unit while DC3 would be compressed in a different bucket; due to the high degree of similarity, compressing DC1 and DC2 as a unit results in a compressed file of 124 bytes, which is 90 bytes less than if DC1 and DC2 has been compressed individually. Accounting for DC3 (which is not in the same bucket), then application of the noted embodiment would only require 223 bytes (124+99).

The above example may initially suggest that no savings was achieved by the embodiments relative to DC3; however, this is simply because no other data container 102 has yet been added to the corresponding bucket. When another data container DC4 with an appropriate similarity metric is combined in the same bucket as DC3, substantial memory savings will result akin to the DC1-DC2 combination.

The improvements in storage is in some respects related to timing and luck. Specifically, it is not preferable for buckets 104 to remain open indefinitely, as they occupy uncompressed space. However, compressing a bucket 106 that is at less than optimum capacity is inefficient. Accordingly, the system may determine whether further storage savings could be obtained by reorganizing the existing relationship between data containers and buckets, potentially including those already stored in memory 116 either alone or in combination with open buckets 106 that are awaiting compression. Such an optimization procedure may be carried out by an examination of the contents of master directory 130, and particularly an optimization directory 112 specifically by considering whether reorganization would result in space savings. Such saving might be realized, for example, if multiple buckets 106 that were closed when less than full could be recombined. This optimization process may also take into account parameters such as access pattern, frequency, and age of data containers within each bucket to be reorganized. For instance, data containers that are frequently accessed for updates should be placed generally in smaller buckets to allow for faster updates.

In another example, the degree of flexibility could be reduced to adjust the precision of the similarity between data containers. For example, two different buckets 106 may have a degree of flexibility of 475-525, and it may well be that it is more space efficient to reorganize the data containers therein into distinct buckets of 475-500 and 501-525. Since a more narrow degree of similarity within the contents of a bucket carries a greater degree of redundancy, the resulting compressed files will tend to require less space than with the larger degree of flexibility.

The above optimization procedure may be triggered by a variety of optional methods. For example, the process could trigger every time at pre-set times or intervals, after a predetermined number of buckets 106 are stored in memory 116, at detected periods of low system activity, and/or when available storage space is below a certain threshold. Combinations are also possible. The invention is not limited to any particular set of conditions.

The above optimization procedure need not pursue perfection. Threshold savings requirements—either absolute or flexible based on the system resources required to implement the optimization—may be required to trigger the optimization. Similar requirements may also be imposed on individual decisions for optimization, e.g., optimization may trigger, but the system may decide to only implement those changes that would achieve a threshold improvement.

By application of the above methodology, every data container 102 stored in buckets 104 may be either identical or just similar to other data containers in the same bucket. The subsequent compression at step S206 by its nature will largely (if not completely) eliminate the duplicative content; such a process is less efficient than the embodiments discussed above, but nonetheless are within the scope of the invention.

As a practical matter, typically only data containers of common type are typically compared against other data containers. There thus may be multiple applications of the embodiments running in parallel for different types of data containers, although the parallel applications may share common resources.

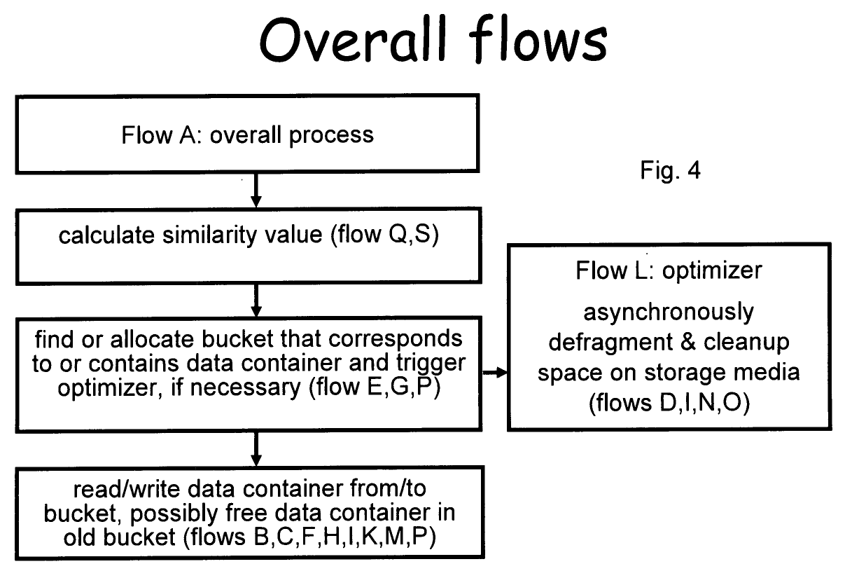

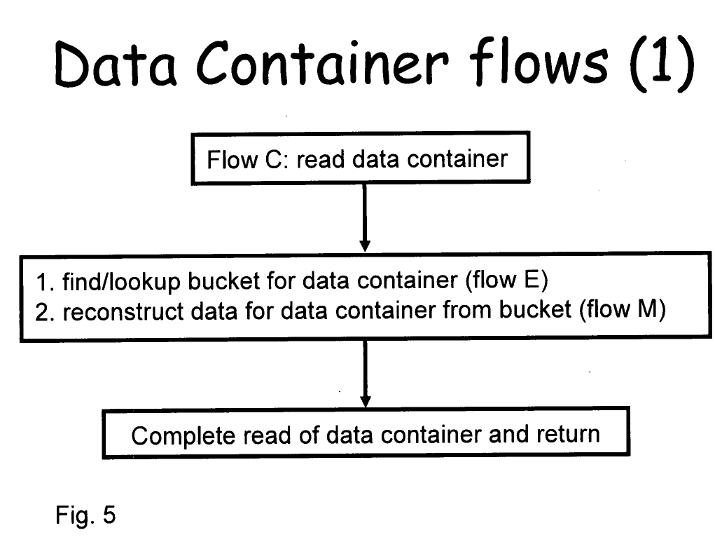

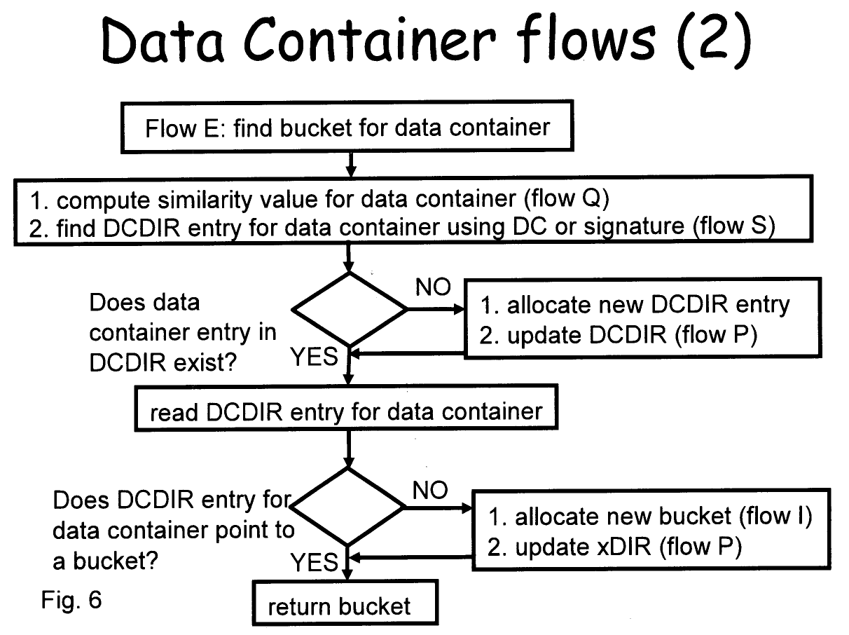

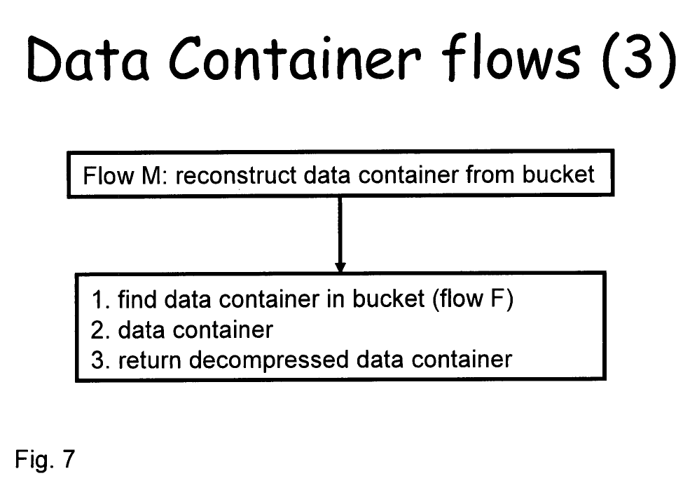

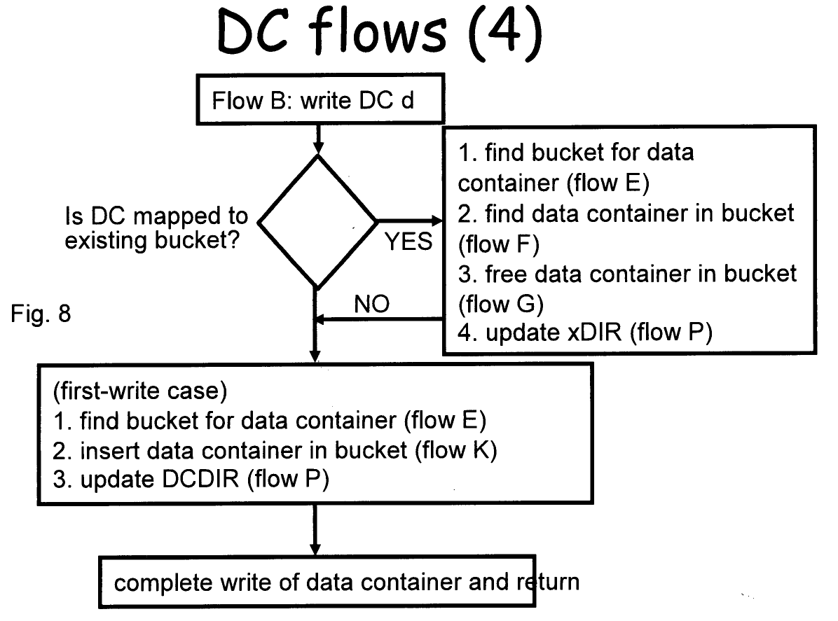

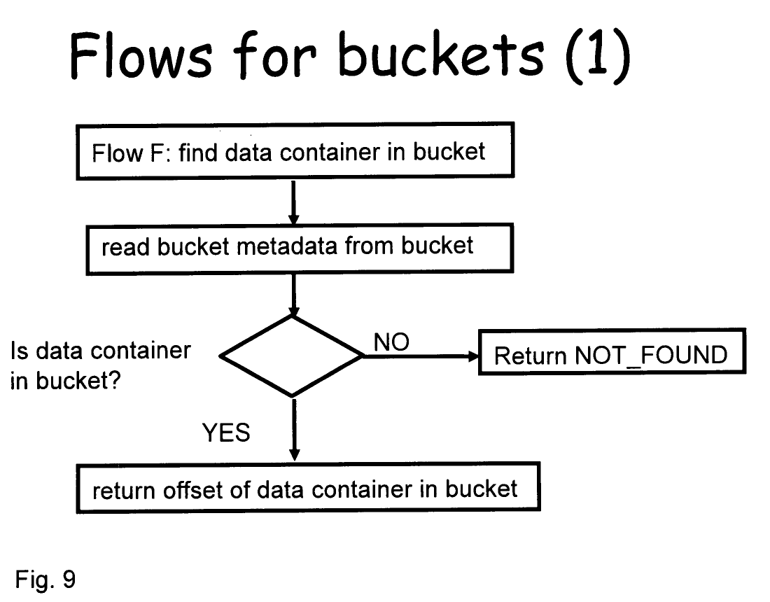

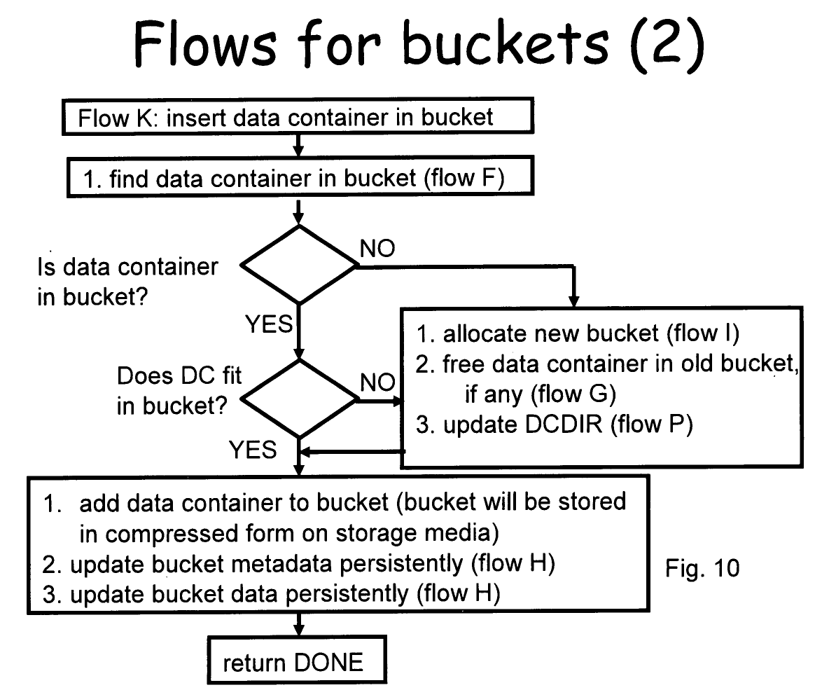

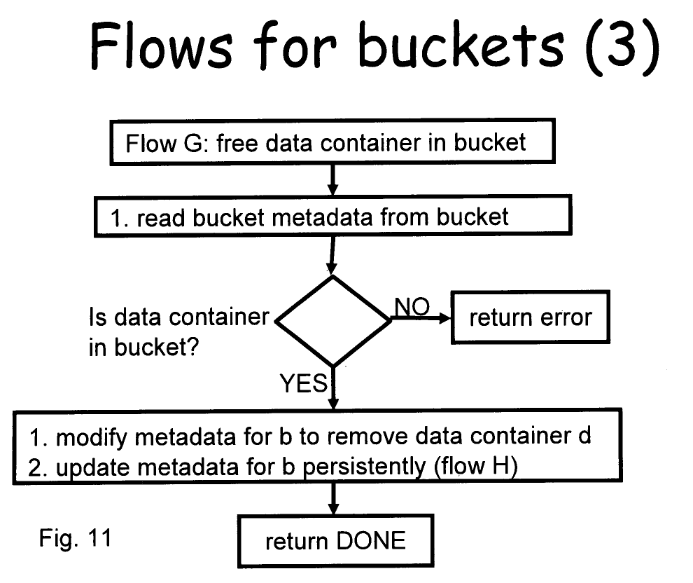

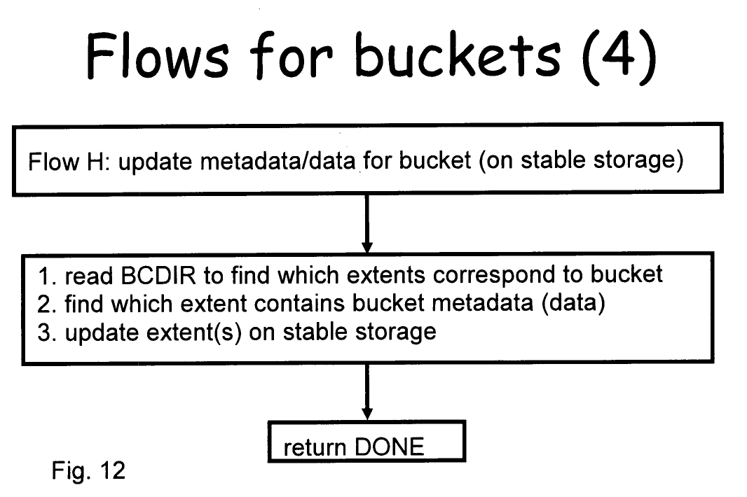

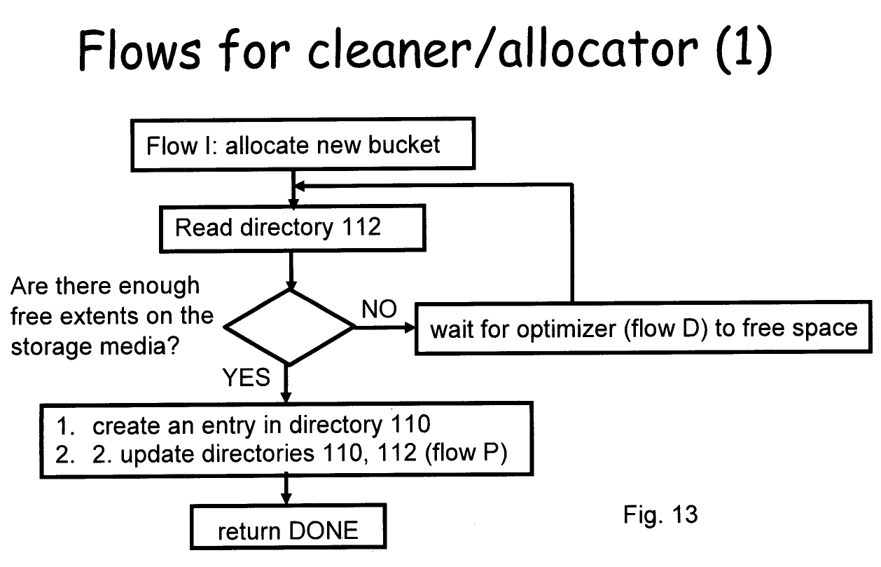

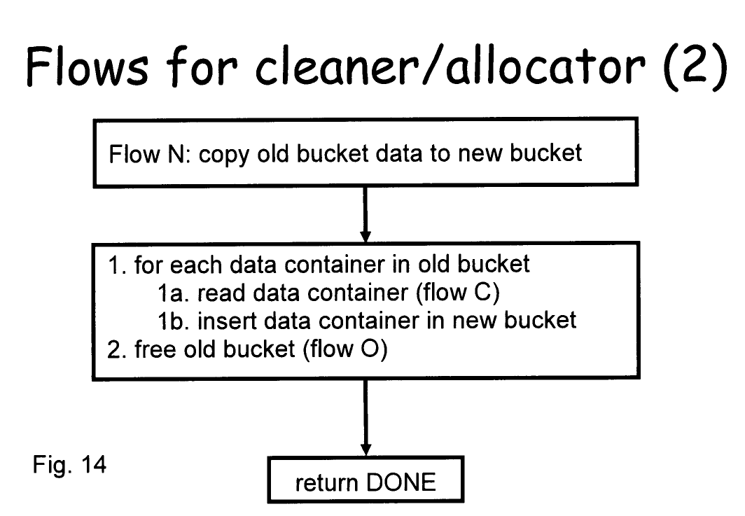

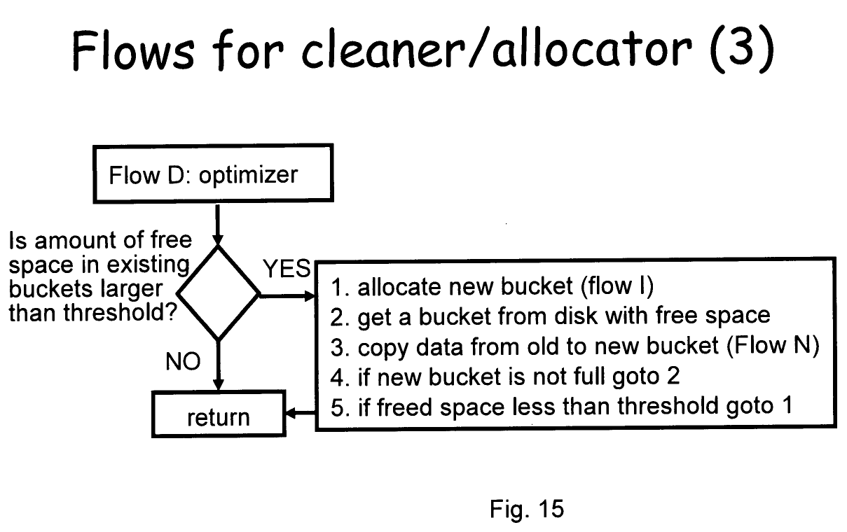

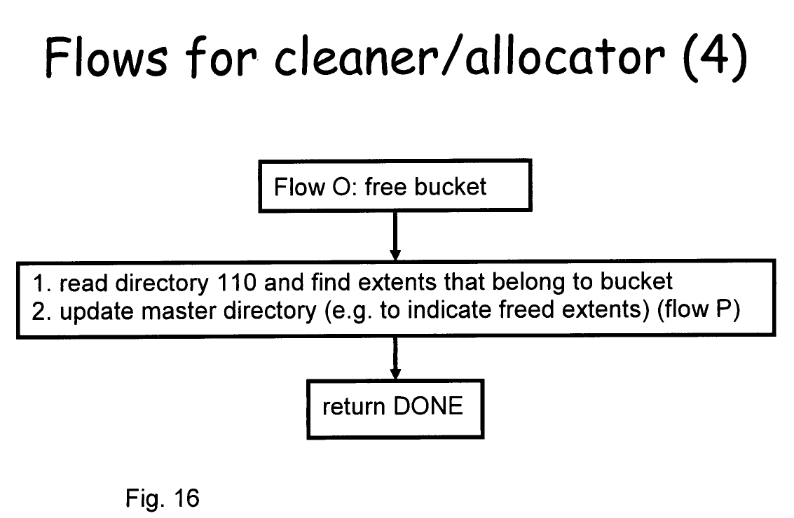

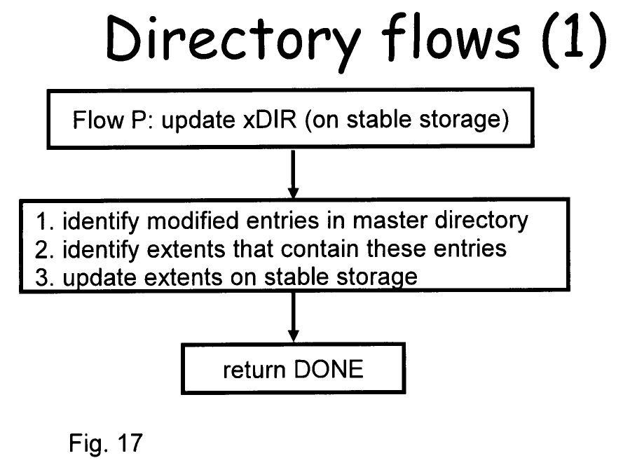

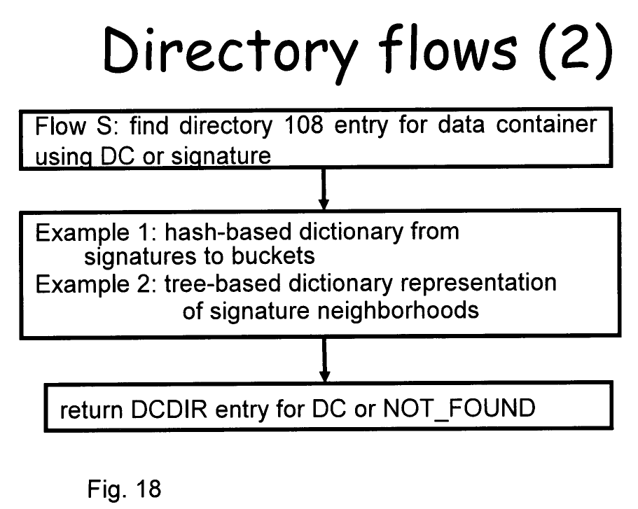

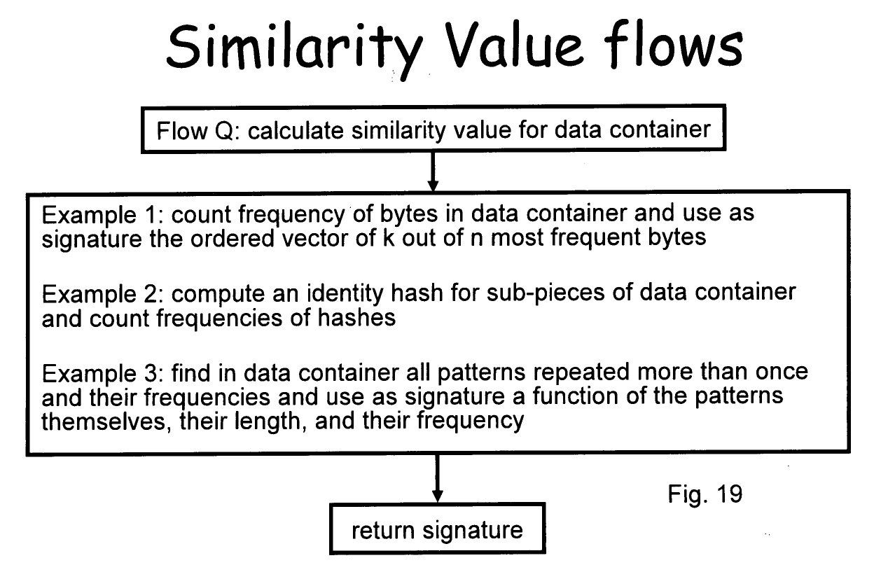

FIGS. 4-19 illustrate the process steps of another embodiment of the invention, in which various steps are provided in greater detail than those discussed above.

The embodiments of the invention are preferably implemented as software written on a computer readable medium and executed in connection with a computer system. General purpose computer and network hardware are anticipated for execution, although special purpose equipment could also be used.

It is noted that the foregoing examples have been provided merely for the purpose of explanation and are in no way to be construed as limiting of the present invention. While the present invention has been described with reference to certain embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims

What is claimed is:

1. A method for managing data, comprising:
providing a plurality of buckets, each associated with a corresponding scope of similarity metric;
processing a first data container of a plurality of data containers to determine a corresponding similarity metric;
comparing the similarity metric of the first data container with the scope of similarity metric of the plurality of buckets;
assigning, if the similarity metric of the first data container matches the scope of similarity metric of any of the plurality of buckets and the corresponding bucket has sufficient available space, the first data container with the corresponding one of the plurality of buckets;
creating, if either the similarity metric of the first data container does not match the scope of similarity metric of any of the plurality of buckets or a match is present but any of the corresponding buckets do not have sufficient available space, a new bucket for the plurality of buckets, and subsequently associating the first data container with the bucket; and
compressing as a unit, when at least one condition is met, any of the plurality of data containers assigned by said assigning to a particular one of the plurality of buckets.

2. The method for managing data, of claim I, comprising:
storing, after said compressing, the compressed bucket into one or more fixed size extents.

3. The method for managing data, of claim I, comprising:
rearranging, when at least one condition is met, the assignment of data containers to compressed buckets;
wherein as a result of said reorganizing, the compressed buckets are smaller in size than prior to said reorganizing.

4. The method for managing data, of claim 3, wherein the at least one condition includes any of said assigning, said compressing, a pre-set time, a pre-set interval relative to a prior reorganization, after a predetermined number of buckets are stored in a memory, a detected period of low system activity, or available storage space for the buckets is below a threshold.

5. The method of managing data of claim 1, wherein said processing is responsive to at least one of a request to write an individual data container, a predetermined number of write requests for individual data containers, a pre-set time, or a pre-set interval relative to a prior processing.

6. The method of claim 1, wherein if during said assigning, competing availability exists between multiple buckets within the plurality of buckets to receive the data container, then the competing availability is resolved by at least one of the first identified available bucket, the oldest bucket, or the most efficient overall placement.

7. The method of claim I, wherein the scope of similarity metric is at least one of a single similarity metric, a plurality of similarity metrics, or one or more ranges of similarity metrics or a similarity metric with an associated degree of flexibility.

8. The method of claim I, further comprising:
receiving a second data container;
determining whether the second data container is identical to any of said plurality of data containers that has been previously assigned to one of said plurality of buckets; and
said assigning being contingent upon a negative result of said determining.

9. The method of claim 1, wherein at least two data containers will be assigned by said assigning to a common bucket, and wherein said compressing will substantially eliminate redundancy between said at least two data containers while preserving differences between the at least two non-identical data containers.

10. The method of claim I, further comprising storing in at least one directory the relationship between the first data container, the corresponding similarity metric, the assigned bucket, and the location of the assigned bucket as compressed in memory.

11. A computer program in computer readable format stored on a computer readable medium, the computer program being configured to operate in conjunction with a computer system to manage data according to the steps comprising:
providing a plurality of buckets, each associated with a corresponding scope of similarity metric;
processing a first data container of a plurality of data containers to determine its similarity metric;
comparing the similarity metric of the first data container with the scope of similarity metric of the plurality of buckets;
assigning, if the similarity metric of the first data container matches the scope of similarity metric of any of the plurality of buckets and the corresponding bucket has sufficient available space, the first data container with the corresponding one of the plurality of buckets;
creating, if either the similarity metric of the first data container does not match the scope of similarity metric of any of the plurality of buckets or a match is present but any of the corresponding buckets do not have sufficient available space, a new bucket for the plurality of buckets, and subsequently associating the first data container with the bucket; and
compressing as a unit, when at least one condition is met, any of the plurality of data containers assigned by said assigning to a particular one of the plurality of buckets.

12. The computer program for managing data, of claim 11, comprising:
storing, after said compressing, the compressed bucket into one or more fixed sized extents.

13. The computer program for managing data, of claim I 1, comprising:
rearranging, when at least one condition is met, the assignment of data containers to compressed buckets;
wherein as a result of said reorganizing, the compressed buckets are smaller in size than prior to said reorganizing.

14. The computer program for managing data, of claim 13, wherein the at least one condition includes any of said assigning, said compressing, a pre-set time, a pre-set interval relative to a prior reorganization, after a predetermined number of buckets are stored in a memory, a detected periods of low system activity, or available storage space for the buckets is below a threshold.

15. The computer program of managing data of claim I 1, wherein said processing is responsive to at least one of a request to write an individual data container, a predetermined number of write requests for individual data containers, a pre-set time, or a pre-set interval relative to a prior processing.

16. The computer program of claim I 1, wherein if during said assigning, competing availability exists between multiple buckets within the plurality of buckets to receive the data container, then the competing availability is resolved by at least one of the first identified available bucket, the oldest bucket, or the most efficient overall placement.

17. The computer program of claim 11, wherein the scope of similarity metric is at least one of a single similarity metric, a plurality of similarity metrics, or one or more ranges of similarity metrics, or a similarity metric with an associated degree of flexibility.

18. The computer program of claim 11, further comprising:
receiving a second data container;
determining whether the second data container is identical to any of said plurality of data containers that has been previously assigned to one of said plurality of buckets; and
said assigning being contingent upon a negative result of said determining.

19. The computer program of claim I 1, wherein at least two non-identical data containers will be assigned by said assigning to a common bucket, and wherein said compressing will substantially eliminate redundancy between said at least two non-identical data containers while preserving differences between the at least two non-identical data containers.

20. The computer program of claim 11, further comprising storing in at least one directory the relationship between the first data container, the corresponding similarity metric, the assigned bucket, and the location of the assigned bucket as compressed in memory.

21. The method of claim 3, further comprising a predetermined policy for determining a size and storage location of buckets within storage based on at least one characteristic of any data containers associated with particular buckets, the at least one characteristic including an access characteristics, and said reorganizing being at least partially based on the predetermined policy.
